(19) United States
(12) Patent Application Publication
(10) Pub. No.: US 2014/0216991 A1
(43) Pub. Date: Aug. 7, 2014

(54) METHOD FOR SEPARATING A FREE-FLOWING MIXTURE IN A FLOWING MEDIUM AND APPARATUS FOR CARRYING OUT SAID METHOD

(71) Applicant: Vladimir Stepanovich Suhin, Lugansk (UA)

(72) Inventor: Vladimir Stepanovich Suhin, Lugansk (UA)

(21) Appl. No.: 14/236,952

(22) PCT Filed: Jul. 26, 2010
(86) PCT No.: PCT/UA2010/000049

§ 371 Date: Feb. 4, 2014

(30) Foreign Application Priority Data
Jan. 22, 2010 (UA) 2010 00630

(51) Int. Cl. B07B 4/02

(52) U.S. Cl. CPC B07B 4/02
USPC 209/644

(57) ABSTRACT

Use in agriculture for preparing seeds by dividing the seeds into fractions and cleaning foreign bodies and dust from the seeds; the method comprises gravitationally feeding in particles of the mixture to be separated, subjecting said particles to an aerodynamically monotonically increasing effects on them at an acute angle to the vertical with a cascade of slot jets in a mode of resonant auto-oscillatory movement of each jet and of the entire cascade of jets at the frequency of the first harmonic half oscillation, and discharging the prepared fractions, where the lightest solid volatile fractions of the foreign bodies are calibrated according to size into two independent fractions, where the finest fraction together with some of the air stream which has already been used is returned to the generator in which the foreign bodies are accelerated, where a second, larger fraction of volatile foreign bodies is immediately and removed together with the dust and the rest of the stream of air; the apparatus comprises a hopper with a vibrating trough, a jet generator mounted there below, with slot nozzles which are arranged one under another and at an acute angle to the vertical and the height of the cross sections of which, and the mounting pitch and angle, increase from the top downwards, and the generator is connected to a source for pressured feeding air into the generator and is enclosed by lateral walls to prevent air leakage from the environment onto generator, the separating chamber under which fraction collectors are arranged, the output from separating chamber is covered by a filtering element which is in the form of a rotating drum with a calibrating sifter on the surface, where said sifter being equipped on the external side with purifier against solid foreign bodies which cannot pass there through, the internal cavity of the rotating drum is connected to a drive for supplying air into the slot jet cascade generator, the purifier is in the form of a slotted confuser, ventilator and cyclone with a waste hopper which are arranged consecutively, wherein the filtering element adjoins the confuser slot with a guaranteed gap, where one of the edges of the confuser is equipped with the cleaning element; technical advantages: energy saving clean grain from the adhesive layer of dust, environmentally friendly production.

### BACKGROUND OF THE INVENTION

1. Field of the Invention

The invention relates to methods and devices for separating a free-flowing mixture in a flowing medium or air in the food processing, chemical and other industries, as well as in agriculture to prepare seeds for sowing and for selection purposes.

2. Description of the Related Art.

A method for separating a free-flowing mixture in a flowing medium, comprising of supplying said mixture of particles with the same speed, exposing them to a uniform stream of air and outputting of finished fractions [see AS USSR number 1176976 in class 07 in April 2002 published on Sep. 7, 1985, in the Bulletin number 33].

A device for separating a free-flowing mixture comprising a fan with an outlet located above the loading hopper and their adjacent compilations of ready-made fractions with a device for screening of light particles [see AS USSR number 1763051 in class 07 in April 2002 issued on Sep. 23, 1992, in Bull. Number 35].

In said method and apparatus, the air stream impacts to an individual free-flowing mixture in single application and only to the random side. Therefore, the quality (accuracy) of the separation process is very low and rough. For this reason, these methods and devices are used primarily for pre-cleaning free-flowing mixture of light foreign bodies, which are their major drawbacks.

Another known method for separating a free-flowing mixture comprises gravitationally feeding in particles of the mixture to be separated, subjecting said particles to an aerodynamically increasing action at an acute angle to the vertical with a cascade of slot jets and discharging the prepared fractions. Impact exercised in free alternating power scan with increasing amplitude and the scan angle. Device for carrying out the method comprising a hopper with a vibrating trough, the air jets generator mounted underneath; where its air jets arranged one underneath another with its slot nozzles at an acute angle to the vertical; height of the cross-sections of which, pitch and setting angle of the apparatus increasing downwards. Thus the generator connected to a supply of air into it under pressure, and also the generator covered sidewalls. The apparatus comprises compilations of fractions, located under the nozzle [see stalemate. Ukraine No 45881 class B 07 B April 2002 Apr. 15, 2002 published in the Bulletin of the year. Number 4 of year 2002].

In this method for separating a free-flowing mixture into the fracture occurs due to the difference of their weight ratio and aerodynamic drag forces. This method is more accurate and more stable over time, due to a special mode of the impact of the air jets on the particles of the mixture, especially by separation of particles of irregular shape. This was possible because the effects of the flow of the cascade jets in scan mode allows repeatedly and variously affect almost every part of the mixture.

But known separation method and apparatus have the following disadvantages. Alternating and the free operation of the cascade jets inevitably leads to a periodic, unstable over time and space in it the appearance of zones of pressure and vacuum with the advent of direct and reverse currents. In the area of the inverse flow occurs retraction of the particles (especially light) in motion reverse to the movement of the main stream of air, which leads to partial mixing of the separated material with not separated. The instability of the time of this phenomenon, eventually results in the deactivation (rupture) of the cascade of jets in any random position, which further increases reverse flow in this zone and, consequently, intensifies mixing the separated material with not separated. In addition, the braking of the jets of air stream contributes disruption generation (termination vibration process), which significantly reduces the quality of separation, bringing it closer to the quality of separation of the usual winnowing machine. These drawbacks of known method are due to imperfection of the device for its implementation, in particular, its generator design of the air jets.

The closest is in essence and in-reach effects, taken for the prototypes are a way of separation of granular mixtures in the fluid and the device for its implementation, the essence of which is as follows:

A method for separating a free-flowing mixture in a flowing medium is a gravity feed particle separated mixture via aerodynamic, monotonically increasing influence on them, at an acute angle to the vertical, of the slot cascade jets and output of finished fractions; wherein aerodynamic effect is carried out in resonant mode of auto-oscillating motion of each jet and the entire cascade jets at the frequency of the first harmonic vibrations. Device for implementing the method of separation of granular mixtures in the fluid comprising a hopper with a vibrating trough, the air jets generator mounted underneath; where its air jets arranged one underneath another with its slot nozzles at an acute angle to the vertical; height of the cross-sections of which, pitch and setting angle of the apparatus increasing downwards; as well generator connected to a supply of pressurized air; sidewalls covered generator to prevent inflow of ambient air into the generator; moreover, the apparatus comprises a separation chamber under which are located compilations of fractions; where each pair of adjacent nozzles is equipped with a resonance chamber connected to their inter-nozzle space. Resonance chamber, in turn, equipped with a device for regulating their volume, wherein the ratio of height of cross section of the nozzle to step of their installation is in the range 0.2-0.25, and the ratio of the uppermost and lowermost angles of the nozzle—0.65-0.75 [see stalemate. Ukraine No 60254 class B 07 B April 2002, A 01 F Jul. 15, 2005 published in the Bulletin. Number 7 of year 2005].

The main drawback of the this method for separating a free-flowing mixture in a flowing medium is that its implementation occurs using open system feeding fluid to the separation process, in particular an air stream. In the known method the air stream sucked into the generator of slot jets from the environment and there is (the environment) is returned after its use for the separation of granular mixture, but “spent” air stream returns naturally already saturated with ordinary dust and volatile foreign bodies of biological origin, which automatically generates a number additional adverse drawbacks of the known method of separation; namely, the deteriorating health of workers, causing lungs problems, and contributes to unwanted allergic reactions (medical flaw), pollutes the environment and the room where the unit is located (environmental disadvantage), despite the high quality of separation, yet reduced the commercial attractiveness of this method because of the constant of a dense cloud of dust in the area of the device separation (economic disadvantage) and even can cause fires, destruction of the facilities, equipment and cause explosion victims because of explosive air-dust mixture when it reaches the appropriate concentration in the room; which, in turn, forces the user of the device to use a powerful ventilation system, that, in general, lowers the cost of finished (the separated) of grain products because of the rising cost of production equipment and energy.

The second essential, and apparently is important drawback of this method for separating a free-flowing mixture in a flowing medium manifested in its application in agriculture (its primary application) for purification and separation of seed or grain crop into fraction, when used as impossible to clean the wheat from the adhesive layer of dust, which is quite tightly wraps the entire surface of each grain, that can be clearly seen during the overload of separated grain material in containers (bags, bins, truck, etc.): appears a thick cloud of dust, but the dust of a different origin. During intersperse of the separated grain material grains collide with each other and mechanically, due to friction, clean off the adhesive layer of dust from each other, and which forms the cloud of dust during overload of the separated grain material. Having dust cloud during overload of the separated grain material, in essence, is direct evidence impossibility of cleaning grain from the adhesive layer of dust in known method, in particular, aerodynamic; there is not enough capacity for air stream. Increase the power of the air stream is not possible, since it dramatically reduces the quality of the separation of the grain material into fractions, since the power of the air stream is in correlation with the physical properties of granular mixture, and therefore, accurately calculated according to the size and weight of the separated material. Since the grain material during separation is not possible to clean by treating it via aerodynamic method with a cascade of slot jets, than it can only affect the grain mechanically, but the well-known way cannot provide such exposure because such manufacturing operation is not available.

Consequently, the said method for separating a free-flowing mixture in a flowing medium allows one to qualitatively separate the grain material into several fractions, but it cannot clear it from the adhesive layer of dust that gives rise to a number of rather offensive problems noted above.

All these disadvantages of method for separating a free-flowing mixture in a flowing medium are due to structural imperfections of the device with which it is carried. The design of the device does not have the filter assembly for cleaning the air stream emerging from separating chamber from dirt and dust, which form together a dangerous cloud near the device during its operation. However, equipping the known device with the filter assembly of any known construction automatically increases the power consumption of the separation process, due to a corresponding increase in generator drive supply power with compressed air depending on the density filter element exerting resistance to air stream. For this reason, devices equipped with filter assembly are not acceptable from the point of view of the economic and energy performance of this method of separation. Besides, the conventional filter elements do not solve the task of cleaning the grain material from the adhesive layer of dust since they do not affect it mechanically, because the separated material is simply not facing the filtering element, because it misses the compilations of fractions disposed generally closer than filters, then the separated material is simply not reached the filters. Therefore, the design of the known device not provided any means for mechanical cleaning of the grain from the adhesive layer of dust, which is its principal disadvantage.

Thus, the disadvantages of the known method for separating a free-flowing mixture in a flowing medium are in a causal relationship with the design deficiencies of the device with which it is carried.

The basis of the invention is to eliminate the above mentioned drawbacks by creation of a method for separating a free-flowing mixture in a flowing medium and a device for implementation by extending the technical and functional features, by equipping device with the assembly of recovery of the air stream with simultaneous saturation of its calibrated solids for simultaneous purification process of grain material from the adhesive layer of dust and its division into separate fractions.

### SUMMARY OF INVENTION

The problem is solved by a method for separating a free-flowing mixture in a flowing medium, comprising gravitationally feeding in particles of the mixture to be separated, subjecting said particles to an aerodynamically increasing action at an acute angle to the vertical with a cascade of slot jets and discharging the prepared fractions, where aerodynamic effect is carried out in a mode of resonant auto-oscillatory movement of each jet and of the entire cascade of jets at the frequency of the first harmonic half oscillation, under the proposal, the lightest solid volatile fractions of the foreign bodies are calibrated according to size into two independent fractions, and finest fraction together with a greater part of the air stream which has already been used for the separation is returned to the generator for forming the cascade of slot jets, in which said solid small fraction of the foreign bodies give acceleration for mechanical impact on the separated material, and second, impassable, a larger fraction of solid volatile foreign bodies, together with dust and the remaining the air stream is immediately and continuously removed to the environment.

This objective is also achieved by the fact that apparatus for implementing the proposed method for separating a free-flowing mixture in a flowing medium, comprises a hopper with a vibrating trough, a jet generator mounted there below, with slot nozzles which are arranged one under another and at an acute angle to the vertical and the height of the cross sections of which, and the mounting pitch and angle, increase from the top downwards, and the generator is connected to a source for pressured feeding air into the generator and is enclosed by lateral walls to prevent inflow of ambient air into the generator; moreover, apparatus comprises a separating chamber under which fraction collectors are arranged; according to the proposal, output from separating chamber is covered by a filtering element which is in the form of a rotating drum with a calibrating sifter on the surface, said sifter being equipped on the external side with purifier for solid foreign bodies which cannot pass there through, wherein internal cavity of the rotating drum is connected to a drive for supplying air into the slot jet cascade generator; where The purifier is in the form of a slotted confuser, ventilator and cyclone with a waste hopper which are arranged consecutively, wherein the filtering element adjoins the confuser slot with a guaranteed gap, one of the edges of the confuser is equipped with the cleaning element made, for example, as a mechanical brush.

As a variation of the device, latest collection of fractions designed for the collection of solid waste of separation process, and cyclone with tank for volatile waste may be combined together into a unitary structure.

A distinctive feature of the proposed method is to reuse most of the air stream pre-cleaned from mechanical foreign bodies, large foreign bodies (not passing through a calibrating sifter), and dust with a filtering element, and saturation of this part of the air, with calibrated solid foreign bodies of small volatile fraction; which are used as a means for mechanical cleaning of grain material from the adhesive layer of dust by the collision of accelerated foreign bodies with grains; which is similar to the process of sandblasting (purification) of conventional metallic materials.

Proposed method of separation, on the one hand, allows eliminating contamination of the environment or the facilities, eliminate noticeable movement of air masses outside of the device, get separation process environmentally safe; and, on the other hand, allows for a mechanical effect on the grain separated material by solid accelerated foreign bodies; which are destructed during collision of adhesion layer of dust on the grain material. In this case, both processes—the separating a free-flowing mixture into fractions and cleaning—occur firstly, simultaneously, secondly, in the same location—the separating chamber.

Thanks to recuperation of the most part of already used air stream in the separation, its automatic saturation with calibrated solid foreign bodies without additional energy costs, use of calibrating sifter as the filter element reduces the total energy consumption of the device for implementing the process of separation into fractions of the grain material, and its purification of the adhesive layer of dust in about 30 times, wherein said processing steps occur without reducing the performance of the device and at the same time improving the quality of the initial treatment of the grain material.

A distinctive feature of the proposed device is its constructive opportunity filtration air stream, its returning to the actuator supply under air pressure air into generator for forming of cascade of slot jets and their saturation with calibrated solid foreign bodies. This filter element in the form of a rotating drum with the calibrating sifter on the surface, collects impassable separated material particles and the foreign bodies on its cylindrical outer side surface; where calibrated fine solid volatile particles (foreign bodies), which got through the calibrating sifter in the middle of the drum, returned with the greater portion of the air stream into generator drive, forming cascade of air jets, but already with saturated calibrated foreign bodies for mechanical cleaning of the grain of the material from the adhesive layer of dust. Designing drum as rotating allows automatically clean its cylindrical surface by cleaning device and exhaust via air stream by confusor, which connected with a cyclone and fan; thus completely remove the foreign bodies and impenetrable dust from that part of the air stream, which is released into the environment.

The technical result of the invention is to provide a novel process of simultaneous separation and purification of grain material due to the presence of a closed air system, formed through modifications to the device for the implementation of the proposed method, with a small yield in the environment totally purified air stream, whose power is unobtrusive and safe for workers and staff and can no longer cause any inconvenience to them; as well the technical result is providing means of mechanical cleaning of the grain material from the adhesive layer of dust in the form of a calibrated solid foreign bodies, derived from the very same separated material, by the use in the device specially designed filter element; i.e. device do not use additional materials for cleaning grain! The quality of material separation does not decrease when multi-fractional stratification occurs by weight, specific gravity or density; but cleaning quality grain material increases substantially.

Therefore, changing the principle of using a greater part of the air stream, the principle of obtaining means for cleaning grain material in an enclosed space through its recuperation and partial purification, resulting in the expansion of technical and operational capabilities of the device.

Thus, the entire set of essential features of the proposed technical solutions, ensure the achievement of the objectives of the invention.

### BRIEF DESCRIPTION OF THE DRAWINGS

FIG. 1—shows diagram of the device for carrying out the proposed method of separation, side view with the cut for a better display of the design;

FIG. 2—shows diagram of the device, top view; small black dots represent the calibrated solid foreign bodies; transparent ovals depict separated grains material; single arrows show the movement of the air stream in the device; double arrows showing the return of the air stream in the generator to re-forming stage of the slot jets of the cascade for separation.

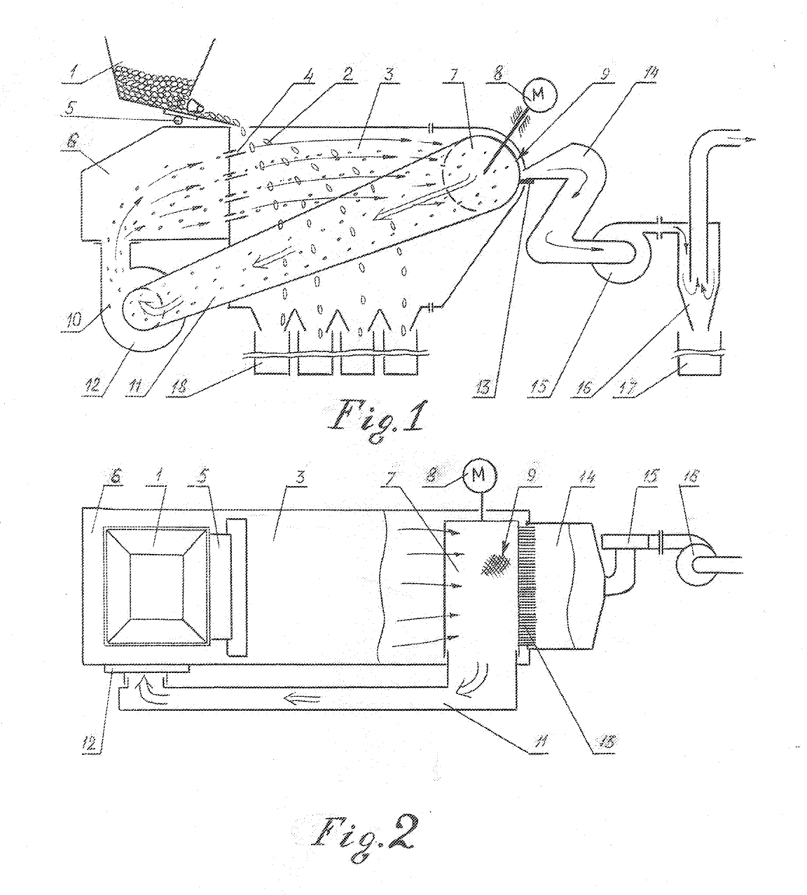

### DESCRIPTION OF THE PREFERRED EMBODIMENT

The apparatus for separating a granular mixture in the fluid comprises of the hopper 1 with vibrating trough 2 for gravity feed of particles in the separation zone.

Under the vibrating trough 2 located jet generator set 3, which is a closed volume with a set of number of slot nozzles 4 designed to generate cascade of slot air jets; slot nozzles 4 are arranged one under another and at an acute angle to the vertical. The height of the cross sections of nozzles 4, the mounting pitch and angle increases from the top downwards. Inkjet generator 3 is aerodynamically connected with a drive 5—a supply for pressured feeding air into generator. The generator 3, is enclosed by lateral walls, preventing inflow of ambient air into the generator. To the generator 3, from the nozzles 4 attached separating chamber 6 under which fraction collectors are arranged. Below separating chamber 6 arranged compilations of fractions 7.

At the end of separating chamber 6, i.e. on the side opposite of the jet generator 3 located filter element having a design in the form of a rotating cylindrical drum 8 with calibrating sifter 9 (filter) on its cylindrical surface. One end of the drum 8 is also closed by calibrating sifter 9 and is connected with a rotating drive 10. The second end of the drum 8 is open; it's connected to the air duct 11, the opposite end of which is adjacent to the drive 5, which is responsible for supplying air under pressure to the jet generator 3. Cleaner of air stream from impassable foreign bodies through calibrating sifter 9 made in the shape of successively situated slit confusor 12, suction fan 13 and the cyclone 14 with the tank 15 for collecting products of cleaning by the air stream. Slit confusor 12 is connecting directly to the calibrating sifter 9 of the rotating drum 8 with the guaranteed gap. One of the edges (no matter which) of the slit confusor 12 is provided with a scraper 16, made for example in the form of a conventional manual brushes with bristles.

A method for separating a free-flowing mixture in a flowing medium using the proposed device implemented as follows (using example of separation of the grain material).

Grain material is charged into the hopper 1. Next, perform the gravity feed of grains 17 of the separated material in the separating chamber 6 from side of the nozzles 4. To perform this operation vibrating trough 2 is using. The grains 17 in free fall having impact at an acute angle to the vertical by cascade of slot jets in mode of developed turbulence generator 3, which is formed due to curvatures of jets during their expansion in the nozzles 4. At the output of the separating chamber 6, laden with dust and mechanical foreign bodies of different caliber air stream abuts the rotating drum 8, which almost completely covers the output of separating chamber 6 as almost equal to its width. The air stream comes through the calibrating sifter 9 inside the rotating drum 8, where impassable in size solid foreign bodies remain on the drum 8 (on the surface of calibrating sifter 9). Thus occurs cleaning of air stream from the large foreign bodies and partly of conventional dust. After calibrating sifter 9 passable solids 18 fall together with part of the air stream inside the rotating drum 8. This part of the air stream together with the calibrated solids 18 gets into the air duct 11 and through it back into the drive 5, almost involuntarily, through the exhaustion of air from the air duct 11 via drive 5. As the drum 8 rotates, its surface (calibrating sifter 9) constantly cleared of impassable solids with help of scraper 16. All waste from separation process and dirt enter the slit confuser 12 due to its suction via air stream formed by fan 13, and then fall into the cyclone 14, where they are separated from the air and hence fall into the tank 15 for its collection. From the cyclone 14 fully clean airs go into the environment by weakly potent almost imperceptible stream.

Returned to the drive 5 part of the air stream with the calibrated solid foreign bodies 18 enters the generator of jets 13 from where it supplied to the nozzles 4, where calibrated solid foreign bodies 18 receive acceleration via cascade of slot jets of air. Accelerated calibrated solid foreign bodies 18 encountering grain material 17 destroys the adhesive layer of dust on its surface, which separates and enters into the air stream; where cleaned grain material 17 is fractionated and falls into the appropriate fraction collector 7. The exhaust air stream encounters a rotating drum 8 and the whole process of recovery of the air stream for the saturation of its calibrated solids 18 repeats.

The essential difference of the proposed technical solutions from previously known, is the recovery of the air stream and the saturation of it with calibrated solid foreign bodies withdrawn from the separated material, and in that the device is provided with a filtering element in the form of a rotating drum with calibration sifter on the surface, which is connected with a suction device in the form of successively connected confuser, fan and cyclone. Given the differences combined allow not only qualitatively separate granular mixture into individual fractions, but mechanically clean it of adhesive layer of dust through mechanical effects on the particles via accelerated calibrated solid foreign bodies, and thus get high quality purified product of separation. None of the known separation methods and devices for their implementation may possess these properties, because either they have no means for cleaning loose granular mixture, or have filters, which are completely clean the air, but they spent more energy than filtering through the calibrating sifter.

Experimental model of the proposed device for the implementation of the proposed method of separation of granular mixture in the fluid medium during the tests showed that during the process of separation grain mixture, wheat in particular, on fractionation, at an output of 10 tons per hour, the air stream rate was 3600 m3 per hour. According to the proposed design scheme for air cleaning is required fan power only 2 kW. To obtain the same effect using a conventional filter element needed power of approximately 60 kW that is 30 times greater.

The proposed technical solution is tested in practice, consists of the usual parts and components, contains no elements or processes that cannot be replicated at the present stage of development of science and technology, from which it follows that it is industrially useful. In the known sources of information is not detected such separation methods and devices for its implementation of analogous purpose with these distinctive features and advantages, that is a confirmation of the marked achievements of the technical result, and therefore is considered to be such that they can receive legal protection.

### TECHNICAL ADVANTAGES OF THE INVENTION

The technical advantages of the proposed technical solution, compared with the prior art, include the following:

cleaning grain material from the adhesive layer of dust due to mechanical impact via calibrated solid foreign bodies;

combination of processes separation for fractionations and purification in time and space due to saturation of air stream by calibrated solid foreign bodies;

reducing the air intake of the environment by returning it to the generator of the cascade jets;

reduce energy consumption for air purification by using calibrating sifter as the calibrating element;

improving the quality of treatment of granular mixtures due to the above benefits;

expansion of technical and functional capabilities of the device by equipping it with the filter element and a means for the recovery of the air stream;

automatic saturation of the recovered part of the air stream with calibrated solid foreign bodies due to the presence of calibrating sifter;

stability of the separation and purification processes in time due to constant rotation of the drum and cleaning by calibrating sifter.

Social impact of the introduction of the invention in comparison with the prototype is obtained by improving working conditions, eliminating of the causes of lung diseases and development of allergic reactions, refraining from pollution of the environmental and industrial premises, and improving fire safety.

The economic effect of the introduction of the invention in comparison with the prototype obtained by improving the commercial appeal of the device, which contributes to its sale, and due to this, the introduction of production environmentally friendly equipment, gaining a purified grain material from the adhesive layer of dust, and reducing energy consumption for cleaning the exhaust air stream.

After the description of the method for separating a free-flowing mixture in a flowing medium and apparatus for carrying out said method, specialists in the field should find it apparent that all of the above is merely illustrative, and not restrictive to the shown examples.

Numerous possible modifications of elements of the device, in particular, drum design and its dimensions, use of the material for the calibrating sifter, confusor shape and design, cyclone type, design and shape of the return air duct and guillemot, may vary depending on the initial separated materials, air pollution, the type and properties of foreign bodies, and located within the scope of one of ordinary and natural approach in the art and considered to be within the scope of the proposed technical solutions.

The quintessence of the proposed technical solution is that the air used for forming slot jets in process of separation, cleaned and returned for reuse, i.e. circulated in the device for separating a granular mixture in the fluid, and, in addition, also saturates with calibrated solid foreign bodies used as a means of mechanical impact on the particles of the granular mixture for its cleaning, and these circumstances have allowed proposed separation method and apparatus for its implementation to acquire said above and other advantages. Exchanging proposed principle of recovery of the air stream and saturation of its by calibrated solids of foreign bodies on the other, naturally limits range of advantages listed above, and cannot be considered as new technical solutions in the field of the art, as others, similar to the described method of separation and apparatus for its implementation does not require any creativity of the designers and engineers, and therefore cannot be considered as the results of their creative work or new objects of intellectual property, which have protection with an enforcement documents in accordance with applicable law.

1. A method for separating a free-flowing mixture in a flowing medium, comprises gravitationally feeding in particles of the mixture to be separated, subjecting said particles to an aerodynamically monotonically increasing effects on them at an acute angle to the vertical with a cascade of slot jets in a mode of resonant auto-oscillatory movement of each jet and of the entire cascade of jets at the frequency of the first harmonic half oscillation, and discharging the prepared fractions, where the lightest solid volatile fractions of the foreign bodies are calibrated according to size into two independent fractions, where the finest fraction together with some of the air stream which has already been used is returned to the generator in which the foreign bodies are accelerated, where a second, larger fraction of volatile foreign bodies is immediately and removed together with the dust and the rest of the stream of air.

2. The apparatus for implementing the method according to claim 1, comprises a hopper with a vibrating trough, a jet generator mounted there below, with slot nozzles which are arranged one under another and at an acute angle to the vertical and the height of the cross sections of which, and the mounting pitch and angle, increase from the top downwards, and the generator is connected to a source for pressured feeding air into the generator and is enclosed by lateral walls to prevent air leakage from the environment onto generator, the separating chamber under which fraction collectors are arranged, the output from separating chamber is covered by a filtering element which is in the form of a rotating drum with a calibrating sifter on the surface, where said sifter being equipped on the external side with purifier against solid foreign bodies which cannot pass there through, the internal cavity of the rotating drum is connected to a drive for supplying air into the slot jet cascade generator, the purifier is in the form of a slotted confuser, ventilator and cyclone with a waste hopper which are arranged consecutively, wherein the filtering element adjoins the confuser slot with a guaranteed gap, where one of the edges of the confuser is equipped with the cleaning element.
